(19) United States
(12) Patent Application Publication
(10) Pub. No.: US 2005/0152235 A1
(43) Pub. Date: Jul. 14, 2005

(54) Data recording method and apparatus

(75) Inventor: Taku Hoshizawa, Yokohama (JP)

Correspondence Address: MCDERMOTT WILL & EMERY LLP, 600 13TH STREET, N.W., WASHINGTON, DC, 20005-3096, US

(73) Assignee: HITACHI, LTD.

(21) Appl. No.: 11/029,362

(22) Filed: Jan. 6, 2005

(30) Foreign Application Priority Data
Jan. 9, 2004 (JP) 2004-003604

(51) Int. Cl. G11B 7/085; G11B 5/09

(52) U.S. Cl. 369/30.16; 369/53.2; 369/47.22

(57) ABSTRACT

A data processing apparatus manages the address of recording data indicative of the outermost location managed by the apparatus, and forces all unrecorded ranges inside of the outermost recording address managed upon additional write prohibition (finalization) to be recorded ranges, thereby accomplishing new finalization which does not limit recording modes without losing such features as “not requiring the finalization or a long time therefor,” and “protection from tampering.”

### INCORPORATION BY REFERENCE

The present application claims priority from Japanese application JP2004-003604 filed on Jan. 9, 2004, the content of which is hereby incorporated by reference into this application.

### BACKGROUND OF THE INVENTION

The present invention relates to techniques for recording and reproducing information on and from an information recording medium.

More particularly, the present invention relates to a data recording method and apparatus for recording and reproducing information on and from an information recording medium such as a write-once optical disc.

A DVD having a capacity of 4.7 Gbytes is coming along, and is becoming increasingly popular on the market, regarded as a high-density and large-capacity optical disc which will be substituted for the CD. Also, in recent years, the standardization has been under way for a next-generation optical disc using a blue laser, permitting us to anticipate the realization of novel features different from the past. One of such features is random recording which enables data to be recorded at a free position on a DVD-RAM independently of a position at which data was previously recorded.

Particularly, with media called write-once discs such as CD-R, DVD-R and the like which cannot be rewritten, data cannot be recorded at random in order to ensure the compatibility to ROM. Also, these media involve processing called “finalization” for recording TOC on the innermost periphery of the media to record a read-out in order for the media to be compatible with ROM discs. This processing has the advantage of physically eliminating free areas to characterize the write-one media (R-media) by “impossibility of erasing (tampering) data from them,” whereas the processing has the disadvantage of requiring a long time for recording the lead-out.

JP-A-2002-324321 has proposed a method of reducing this time for recording the lead-out.

JP-A-2002-324321 has proposed a solution for the foregoing problem, which is applied when information is dubbed from a CD to a CD-R. This solution involves automatically finalizing a recorded CD-R when it is determined that information has been normally dubbed on all tracks.

The write-once optical discs are required by the user “not to limit to a particular recording mode,” “not to involve the finalization, or not to require a long time,” and “to be free of tampering.”

However, the finalization described in JP-A-2002-324321 only supports a conventional recording mode which records data sequentially from the inner periphery to the outer periphery of a disc, but does not specifically provide a finalization method for randomly recorded optical discs.

### SUMMARY OF THE INVENTION

It is an object of the present invention to provide a novel finalization or additional write prohibition method for use in an optical disc recording/reproducing apparatus, which “does not limit recording modes” without losing such features as “not involving the finalization or a long time therefor,” and “free of tampering.”

The foregoing problem is solved in an optical disc recording/reproducing apparatus by managing the address of recording data indicative of the outermost location on the disc managed by the apparatus, and forcing all unrecorded ranges inside of the address at the outermost location, which is managed during the additional write prevention (finalization), to be recorded range.

To achieve the above object, in a first aspect, the present invention provides a data recording method for sequentially recording data on a recording medium having a plurality of recording areas in response to a recording request from a host. The method includes the step of recording information indicative of whether or not an unrecorded portion is included in at least one of the plurality of recording areas on the recording medium.

In a second aspect, the present invention provides a data recording method for sequentially recording data on a recording medium having a plurality of recording areas in response to a recording request from a host. The method includes the steps of recording user data and first identification data on the recording medium in response to a recording request from the host, recording information indicative of whether or not an unrecorded portion is included in at least one of the plurality of recording areas on the recording medium, and sensing an unrecorded portion on the recording medium from the information in response to an additional write prohibition request from the host to record additional write prohibition data and second identification data in the unrecorded portion.

In a third aspect, the present invention provides a data recording apparatus for sequentially recording data on a recording medium having a plurality of recording areas in response to a recording request from a host. The apparatus includes an encoder for generating first identification data in response to a data recording request from the host, and generating second identification data in response to an additional write prohibition request from the host, and an optical pickup for recording user data and the first identification data on the recording medium in response to a user data recording request from the host, recording information indicative of whether or not an unrecorded portion is included in at least one of the plurality of recording areas on the recording medium, sensing an unrecorded portion on the recording medium from the information in response to an additional write prohibition request from the host, and recording the additional write prohibition data and second identification data in the unrecorded portion.

The present invention, when applied, can improve the features of the conventional write-once optical discs such as prevention of recorded data from modification and tampering, even for optical discs which do not limit recording modes, without requiring a long time.

Other objects, features and advantages of the invention will become apparent from the following description of the embodiments of the invention taken in conjunction with the accompanying drawings.

### BRIEF DESCRIPTION OF THE DRAWINGS

FIGS. 1A, 1B, 1C are diagrams showing an additional write prohibition scheme (finalization scheme) according to the present invention;

FIG. 2 is a diagram of identification data (ID) showing data for use in finalization;

FIG. 3 is a flow diagram illustrating a processing order of creating a physical sector;

FIG. 4 is a diagram showing a data sector;

FIG. 5 is a diagram showing identification data (ID);

FIG. 6 is a diagram showing CPR_MAI in a data area;

FIG. 7 is a table showing initial values for a shift register;

FIG. 8 is a schematic diagram illustrating the configuration of a feedback type shift register for generating scramble data;

FIG. 9 is a diagram showing an ECC block;

FIG. 10 is a diagram showing an ECC block after row interleaving;

FIG. 11 is a diagram showing a physical sector;

FIG. 12 is a flow chart illustrating a process of encoding a DVD;

FIG. 13 is a block diagram illustrating a DVD recording/reproducing system;

FIGS. 14A, 14B are diagrams showing a recording block and positions at which recording blocks are recorded on a disc, respectively;

FIGS. 15A, 15B are diagrams illustrating the shape of a disc, and physical addresses on the disc;

FIG. 16 is a cross-sectional view showing a division of the area on a disc;

FIGS. 17A, 17B, 17C are diagrams showing MRA;

FIGS. 18A, 18B, 18C are diagrams showing MRA;

FIGS. 19A, 19B are cross-sectional views each showing a division of a user data area;

FIGS. 20A, 20B are diagrams each showing a fraudulently recorded disc;

FIGS. 21A, 21B are diagrams showing the relationship between management information and MRA;

FIG. 22 is a flow chart illustrating a recording sequence;

FIG. 23 is a flow chart illustrating a reproducing sequence;

FIGS. 24 and 25 are flow charts illustrating in combination a finalization sequence;

FIGS. 26A, 26B, 26C are diagrams each showing a breakdown of a recording block and 16 data sectors 3;

FIG. 27 is a diagram showing identification data (ID) indicative of invalid data;

FIG. 28 is a table listing session information included in the management information; and

FIGS. 29A, 29B are diagrams showing how a disc is recorded when it is divided into sessions.

### DETAILED DESCRIPTION OF THE EMBODIMENTS

In the following, referring to the accompanying drawings, a DVD format will be first described as an example of recording format, followed by description on embodiments in which the present invention is applied to examples of the DVD format. Of course, the present invention is not limited to the DVD format, since it can be adapted to many recording media represented by optical discs.

A data recording format for a DVD will be described.

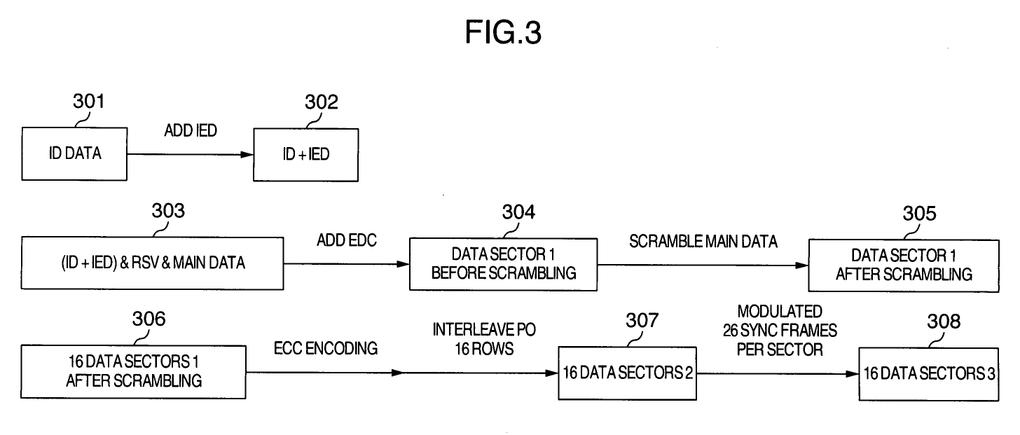

FIG. 3 shows in sequence a processing order for creating a physical sector on a DVD.

The sectors is called a data sector (data sector 1 after scrambling) 305, a recording sector (data sector 2) 307, and a physical sector (data sector 3) 308 in accordance with signal processing steps, and is processed according to the processing order (flow of encode processing) for creating the physical sector as illustrated in FIG. 3.

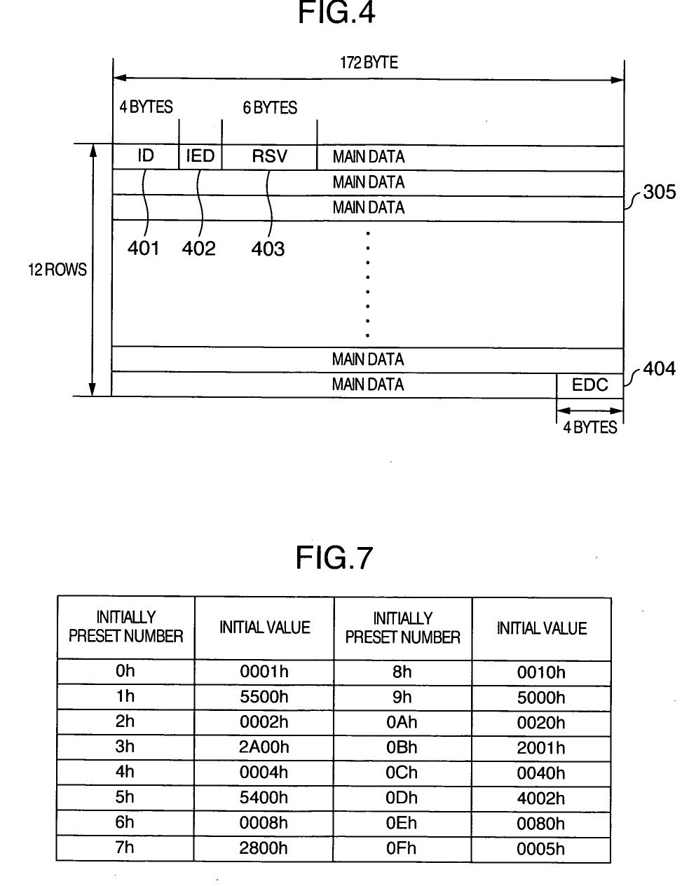

FIG. 4 shows the structure of the data sector 305.

As shown in FIG. 4, the data sector 305 is comprised of 2,048 bytes of main data, 12 bytes of data identification address information such as identification data ID 401, and four bytes of parities for error detection code (EDC) 404, which make up 2,064 bytes of data, and is organized in 172 bytes×12 rows. After calculating the EDC, scramble data is added to 2,052 bytes of main data in the data section 305.

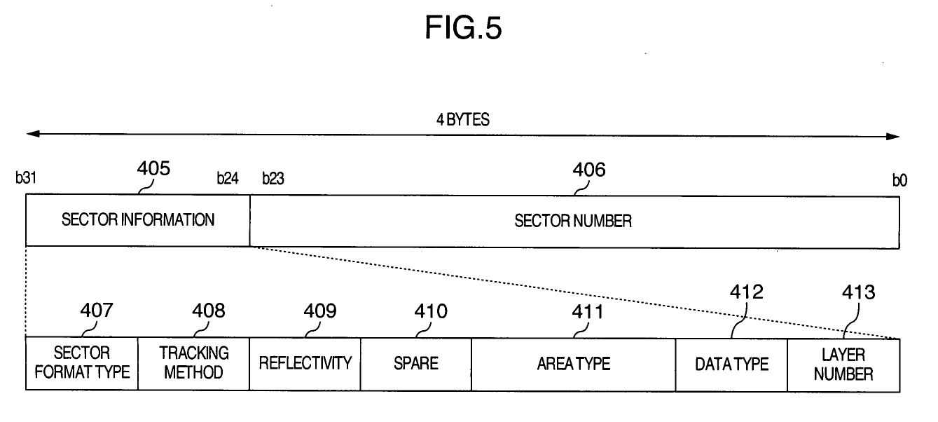

FIG. 5 shows the structure of the ID 401.

The ID is comprised of three bytes of sector information (Data Field Information) 405 and one byte of sector number (Sector Field Number) 406. The sector information 405 includes format type (Sector Format Type) information 407, tracking method information 408, reflectivity information 409 and the like in the disc. The ID also includes area type information 411 indicative of a data area or a lead-in/lead-out area, data type information 412 indicative of reproduction dedicated data or additional write/rewrite data, and layer number information 413 indicative of a layer of the disc. The sector number 406 is a serial number given to the data area. The data area starts at 030000h, and is allocated for storage of data.

The EDC 404 shown in FIG. 4 is a check code appended to the data sector (2,060 bytes) before scrambling. The EDC 404 is relied on for checking whether or not errors are included when the data sector 305 cannot be corrected after error correction processing, or due to an erroneous correction and the like.

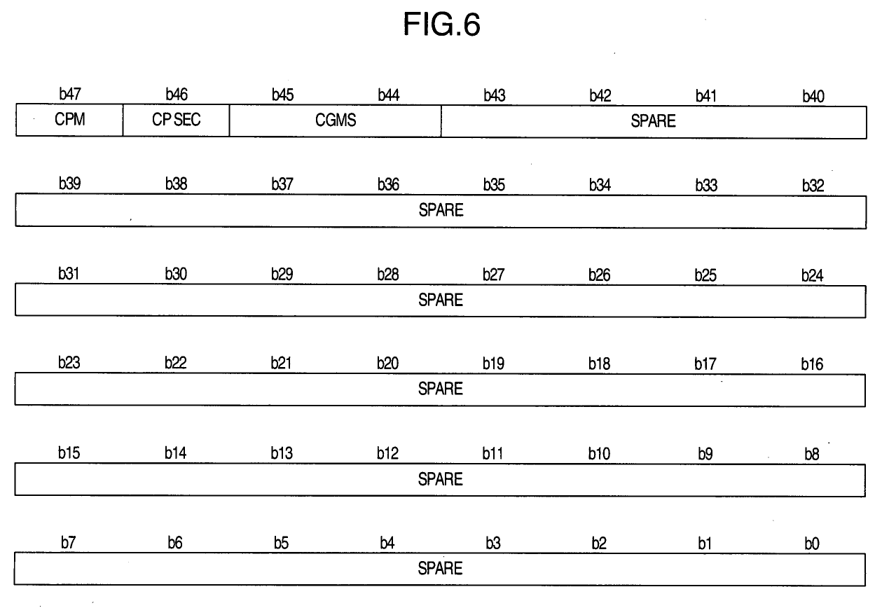

FIG. 6 shows the structure of CPR_MAI (Copyright Management Information) when RSV 403 in the data area in FIG. 4 is used on a DVD-ROM. Currently, four bytes of 48-byte CPR_MAI are used for the DVD-ROM. A byte labeled b47 stores CMP (Copyrighted Material) which indicates whether or not this sector includes a material which is protected by the copy right. A byte labeled b46 stores CP_SEC which indicates whether or not this sector has a particular data structure of a copyright protection system. Bytes labeled b45 and b44 store CGMS (Copy Generation Management System) which records information on a copy limit.

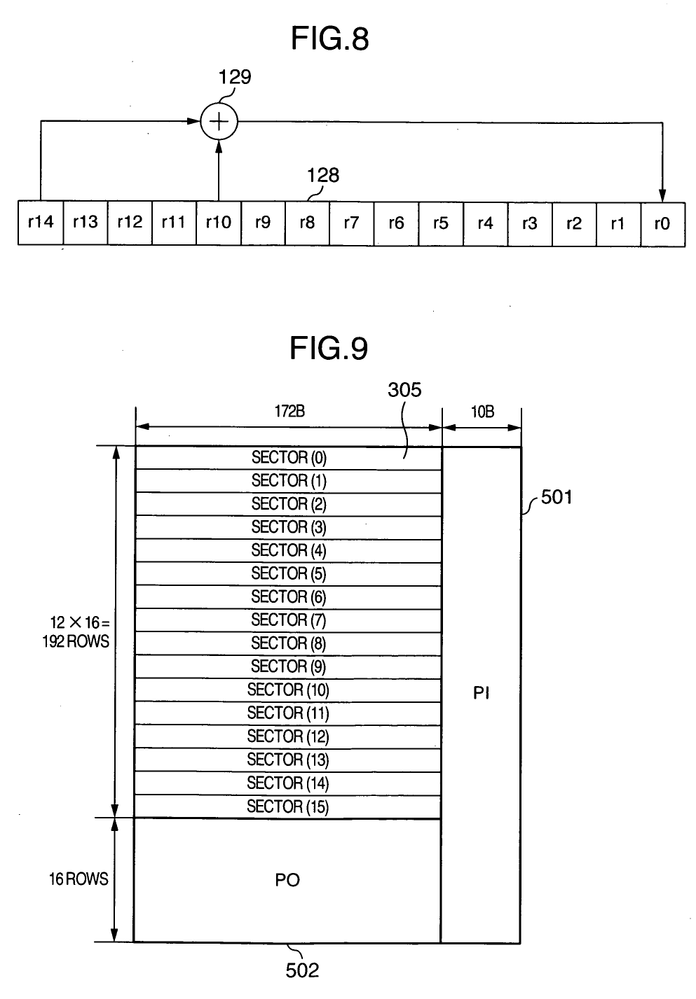

FIG. 7 shows initial values for shift registers, while FIG. 8 illustrates a circuit for generating random data for scrambling, which is used in scrambling. In FIG. 8, the random data generator circuit comprises 1-bit registers 128, and an adder (exclusive-OR) 129. The random data for scrambling is generated by setting an initial value corresponding to an initial preset number shown in FIG. 7 to an initial value of the shift register in FIG. 8, and repeating 8-bit shifts. In the DVD, the initial preset number in FIG. 7 corresponds to four bits from b7 to b4 in the ID. Therefore, the generator circuit generates the same random data for scrambling unless the ID changes.

Subsequently, an error correction code (ECC) block is encoded over 16 data sectors 305. The recording sector 307, which is an error correction encoded sector, is generated by interleaving the sector with parity of outer-code PO and parity of inner-code PI in units of rows. The physical sector 308 is a sector which has a synchronization signal (SYNC code) added to the beginning of every 91 bytes in the recording sector 307.

FIG. 9 shows the structure of the ECC block.

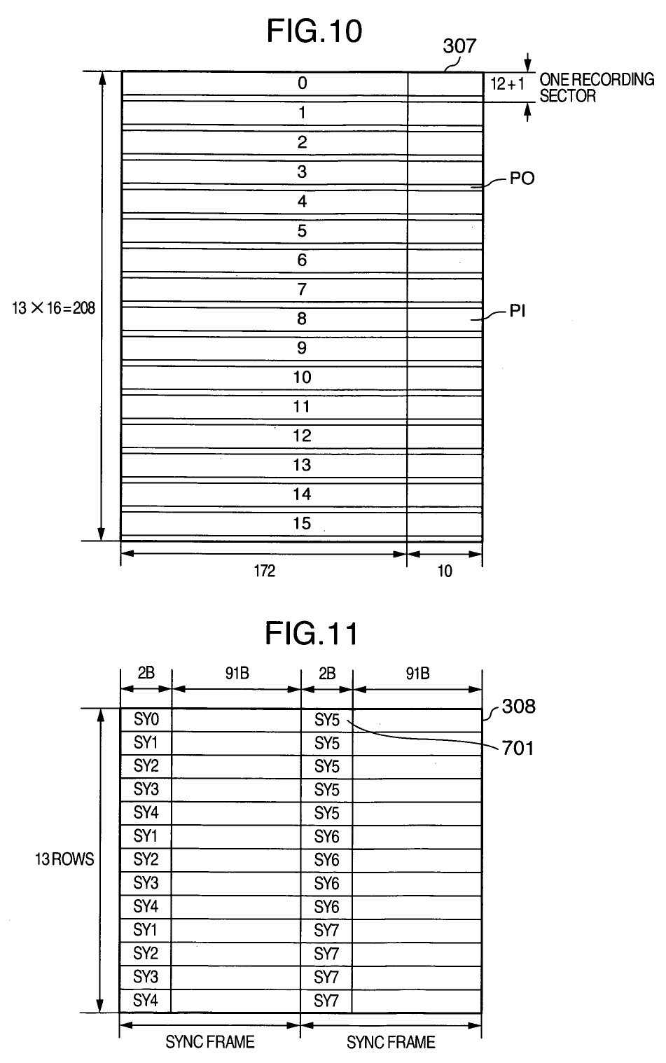

Te ECC block is formed of 16 data sectors 305 which are scrambled as information fields. 192 rows each having a length of 172 bytes, equal to 172 bytes×12 rows×16 data sectors, are allocated for an information field, and 16 bytes of PO 502 are generated by a generator polynomial:
GPO(x)=(x−α0)(x−α1) . . . (x−α15)
Each of 172 columns forms an outer-code of a Reed-Solomon code RS(208,192,17). Next, ten bytes of PI 501 are generated by a generator polynomial:
GPI(x)=(x−α0)(x−α1) . . . (x−α9)
All 208 rows including PO 502 form an inner-code of a Reed-Solomon code RS(182,172,11). The ECC block in FIG. 9 is interleaved in units of rows, and modulated before it is recorded on a disc. This interleaving, as can be seen in FIG. 10, involves inserting 16 PO rows one by one into every 12 rows of the data area. A portion of 13 rows×182 bytes within the ECC block after interleaving is called the recording sector 307, as mentioned above. Therefore, this means that the interleaved ECC block is comprised of 16 recording sectors 307.

FIG. 10 shows the structure of the interleaved ECC block.

The interleaved recording sector having 2,366 bytes in 13 rows each having 182 bytes (13 rows×182 bytes) are sequentially modulated from the beginning on a row-by-row basis, while a SYNC code 701 is added before the zero-th and 91th rows, to create the physical sector 308. The modulated data comprised of the SYNC code 701 and subsequent 91-byte data is called a “SYNC frame.”

As shown in FIG. 11, one physical sector is comprised of 13 sets of two SYNC frames, and has 38,688 channel bits ((two bytes+91 bytes)×2×13 rows×16 bits/byte) because the physical sector is subjected to an 8/16 modulation for converting 8-bit input data to a 16-bit channel bits. FIG. 11 shows a combination of SYNC codes 701. The beginning of a sector can be identified by SY0 (SYNC code “0”), and each row by a combination of SY1-SY4, SY5, SY6, SY7 which repeat in a cyclic manner. Since the error correction is performed in units of ECC blocks, 16 sectors are collected for formation of an ECC block, the beginning of which is recognized by an address, which can be divided by 16, of read ID information subsequent to SY0. Thus, SY0, i.e., the beginning of a sector is highly important for decoding data. Also, SY0 is identified by utilizing the periodicity simultaneously using another SYNC code 701.

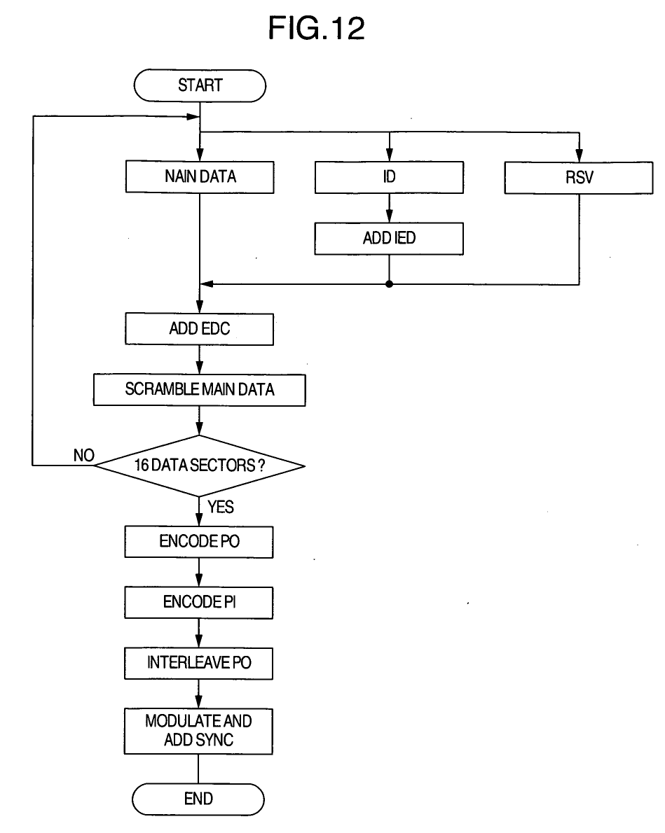

FIG. 12 illustrates in flow chart form the processing performed in the course of generating recording data previously shown in FIG. 3.

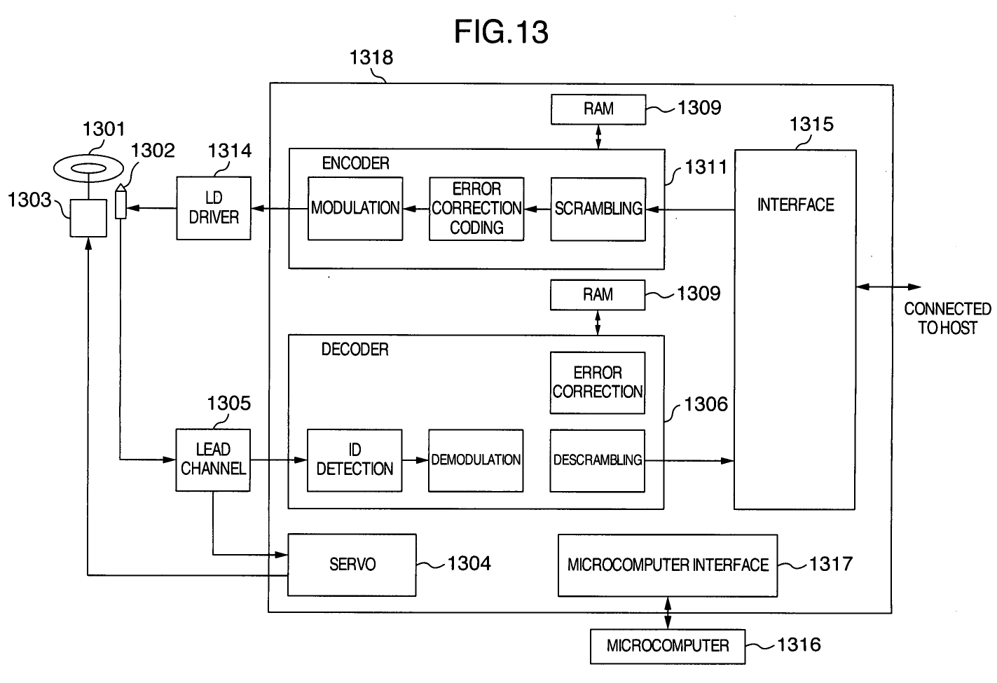

FIG. 13 illustrates an exemplary configuration of an optical disc recording/reproducing apparatus, for example, for use with a recordable DVD drive. The illustrated optical disc recording/reproducing apparatus comprises a pickup 1302 for reading data recorded on an optical disc 1301; a spindle motor 1303 for rotating the disc 1301; and a laser driver 1314. A servo controller 1304 controls the optical pickup 1302 and the like. A read channel 1305 equalizes the waveform of analog reproduced signal read from the disc 1301, binaries the resulting reproduced signal, and generates a synchronization clock. A decoder 1306 demodulates read data, corrects possible errors in the read data, and descrambles the resulting data. A RAM 1309 temporarily stores data. An encoder 1311 modulates, error-correction-encodes, and scrambles data when it is written. An interface 1315 controls input/output of data to/from a higher-rank device. A microcomputer 1316 governs the whole system. Since the configuration illustrated herein is an example of DVD drive connected to a personal computer, the interface 1315 is connected to a personal computer as well as to an MPEG board or a hard disc drive (HDD), by way of example. Of course, the configuration of the recording/reproducing apparatus is not limited to the foregoing, and devices connected to the recording/reproducing apparatus are not particularly limited, but may include a receiver such as a set top box (STB), another video/audio recording/reproducing device, and the like. In the following description, these connection related devices for controlling drives are collectively called the “host.”

One of characteristic features of the optical disc is random accessibility.

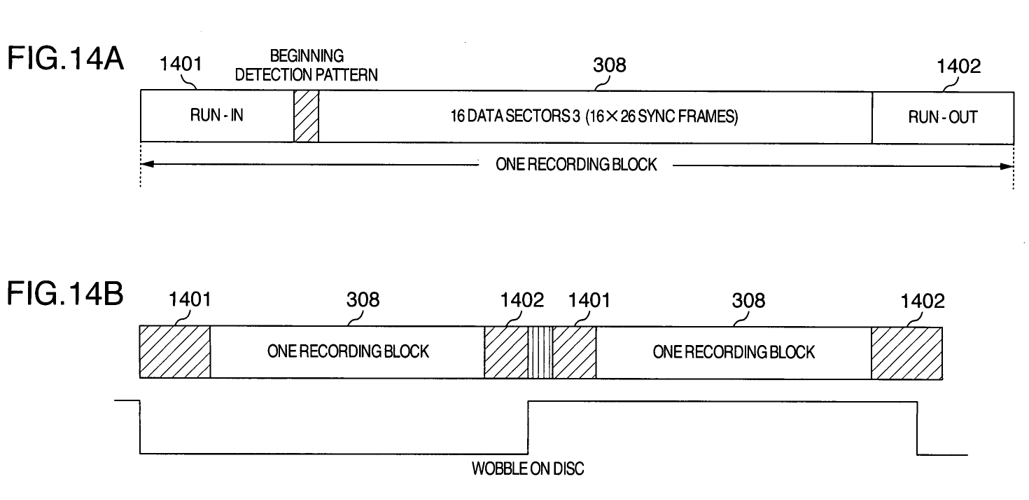

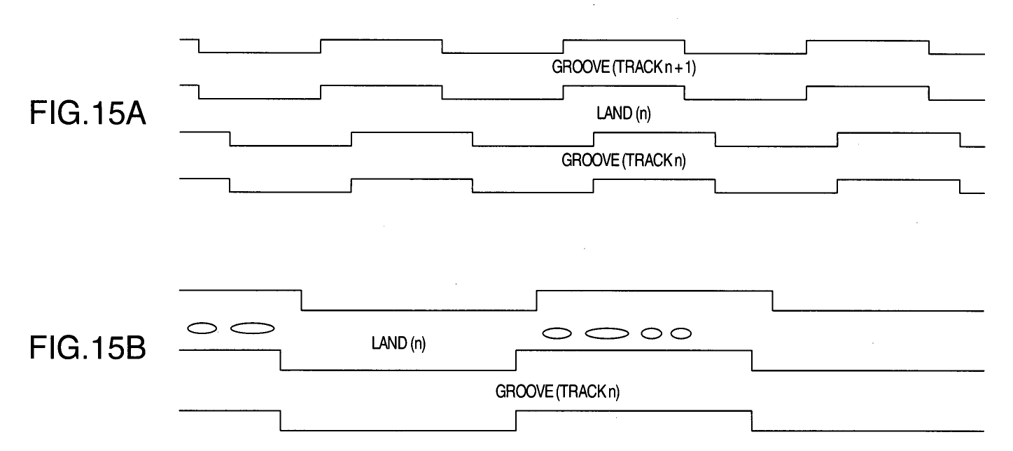

A physical mechanism of the disc for implementing the random accessibility during-recording, i.e., physical address indicative of a location on the disc will be described with reference to FIGS. 14A, 14B, 15A, 15B, together with a discussion as to how the data sector 3 generated in the processing order illustrated in FIG. 3 is positioned on the disc.

Referring to FIGS. 14A, 14B, a run-in comprised of a fixed pattern, and a beginning detection pattern indicative of the beginning of 16 data sectors 3 are added to the head of the 16 data sectors 3 generated by the processing in FIG. 3, or a sequence of data comprised of 16 sets of 26 SYNC frames shown in FIG. 11, and a run-out is added to the tail of the same to form a data sequence which is designated one “recording block.” The recording blocks are positioned on the disc in synchronism with wobbles on the disc, while overlapping the run-out with the run-in. In other words, FIGS. 14A, 14B show that data can be randomly recorded in unit of recording blocks without taking into account the connection of previous and subsequent data according to this scheme.

However, for randomly recording data on a disc, physical addresses indicative of the locations at which data are recorded are required over the entire surface of the disc. FIGS. 15A, 15B show exemplary positioning of physical addresses. Data is recorded in units of recording blocks in synchronism with the wobbles. Therefore, the physical address utilizes the center number at the beginning of 16 data sectors 3 which make up one recording block. The wobbles on the disc are formed of grooves and lands in the shape of recess and protrusion, respectively, spirally from the inner periphery of the disc. Data is recorded on grooves corresponding to the recesses, while the recording data and pits, which can be divided in terms of frequency, are placed on the land to form a physical address indicative of a location on the disc. In the example shown in FIGS. 15A, 15B, one address is provided every two recording blocks. In the optical disc recording/reproducing apparatus as illustrated in FIG. 13, the physical address is detected by the decoder 1306 through the lead channel 1305 for utilization in reproduction and recording. In this event, light for reproducing the physical address on the land is outputted from the pickup 1302, other than light for recording/reproducing data which follows the grooves, and is converted to a voltage by a dedicated optical detector and an IV amplifier in a manner similar to the recording data.

In this way, the addresses are physically set on the disc such that data can be recorded in units of recording blocks, thereby implementing the random accessibility to and random recording on the optical disc.

Next, description will be made on a method, a scheme, and apparatus for protecting a recordable optical disc, particularly, an optical disc called the “write-once optical disc” such as CD-R and DVD-R, from being additional written, in accordance with the present invention.

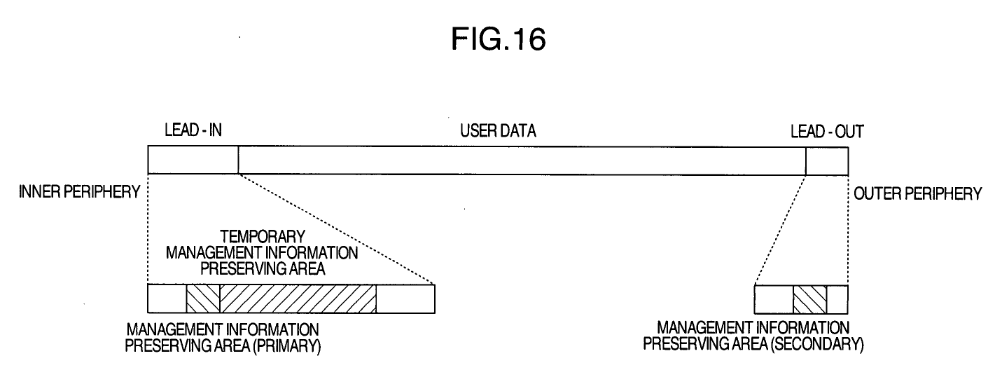

FIG. 16 is a cross-sectional view of a disc, showing that the disc is logically divided into an inner peripheral area, an intermediate area, and an outer peripheral area in accordance with particular purposes. The disc is divided from the inner periphery to the outer periphery into a lead-in area for recording management information on the disc, drive and the like, a user data area for the host to record data and management information on the data, and a lead-out area for recording management information on a drive and the like, similarly to the lead-in area. The lead-in area and lead-out area includes a management information preserving area for recording drive management information, and a temporary management information preserving area for temporarily preserving management information for supporting a write-once optical disc. Assume herein that the management information preserving area has a size only for recording one set of management information, and the temporary management information preserving area has a recording size sufficient for updating the management information. The management information preserving areas are placed near the inner periphery and outer periphery of the disc in order to prevent the inability to reproduce the overall disc in the event of a failure in reproducing data in the management information preserving area (primary) in the inner peripheral region. Assume also that with a write-once optical disc, the temporary management information preserving area and the primary and secondary management information preserving areas are used in the following manner. When the management information preserving area of a disc has not been recorded, an additional write is permitted, and the management information is additionally written into the temporary management information preserving area at all times. At a timing at which it is determined to prevent an additional write into the disc, the latest management information in the temporary management information preserving area is copied into the management information preserving area. The additional write is prohibited when the management information has been recorded in the management information preserving area (primary) or management information preserving area (secondary).

The management information in FIG. 16 includes the maximum recorded address (MRA).

In single-layer optical discs such as CD, DVD and the like, MRA can represents th outermost recorded address because user data is generally recorded from the inner periphery to the outer periphery from a viewpoint of servo control.

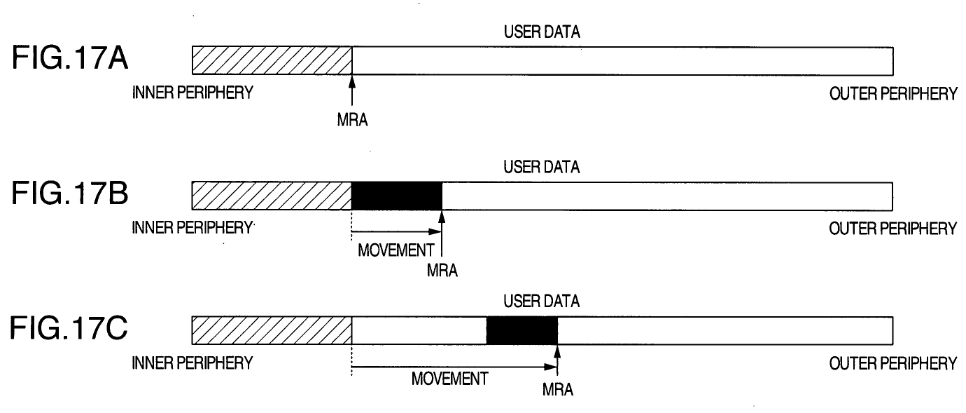

FIG. 17A, 17B, 17C each show the value of MRA for a disc in a particular use situation. In these figures, a section filled with oblique lines rising to the right indicates a recorded range, a solid black section indicates a newly written area, and a white section indicates an unrecorded range.

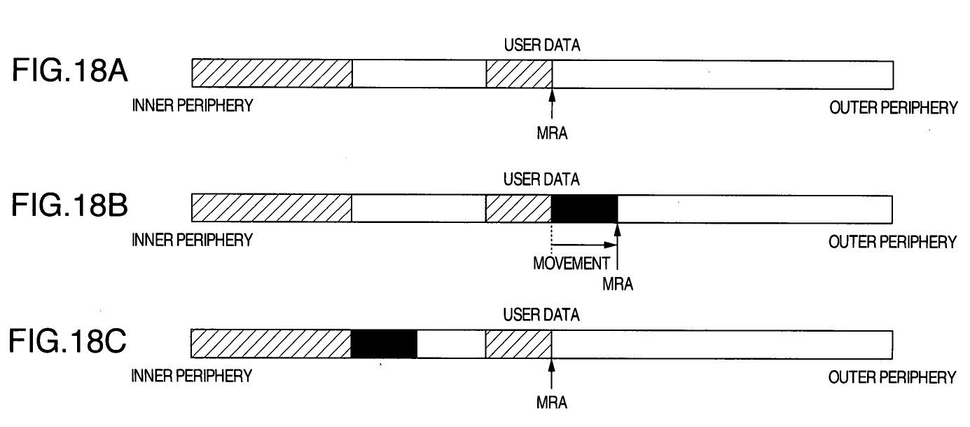

The MRA indicates the address at the outermost location in the user data area to which data has been recorded. When data is sequentially recorded from the inner periphery of the disc as shown in FIG. 17A, the MRA indicates the outermost address in a recorded range to which data has been recorded at the last time. When data is additionally written into the user area from the recorded range shown in FIG. 17A up to the solid black area shown in FIG. 17B, the MRA moves to the outermost location of the newly recorded range. Similarly, when data is recorded into the user area beyond an unrecorded range as shown in FIG. 17C, the MRA moves to the outermost location of the newly recorded range. Supplementary description will be further made with reference to FIGS. 18A, 18B, 18C. When data is additionally written into the user area as shown in FIG. 18B from the state shown in FIG. 17C (FIG. 18A), the MRA moves to the outermost location of the additionally recorded range. When data is additionally recorded from a recorded range on the inner peripheral side, the MRA does not move but still points to the same location as that shown in FIG. 18A.

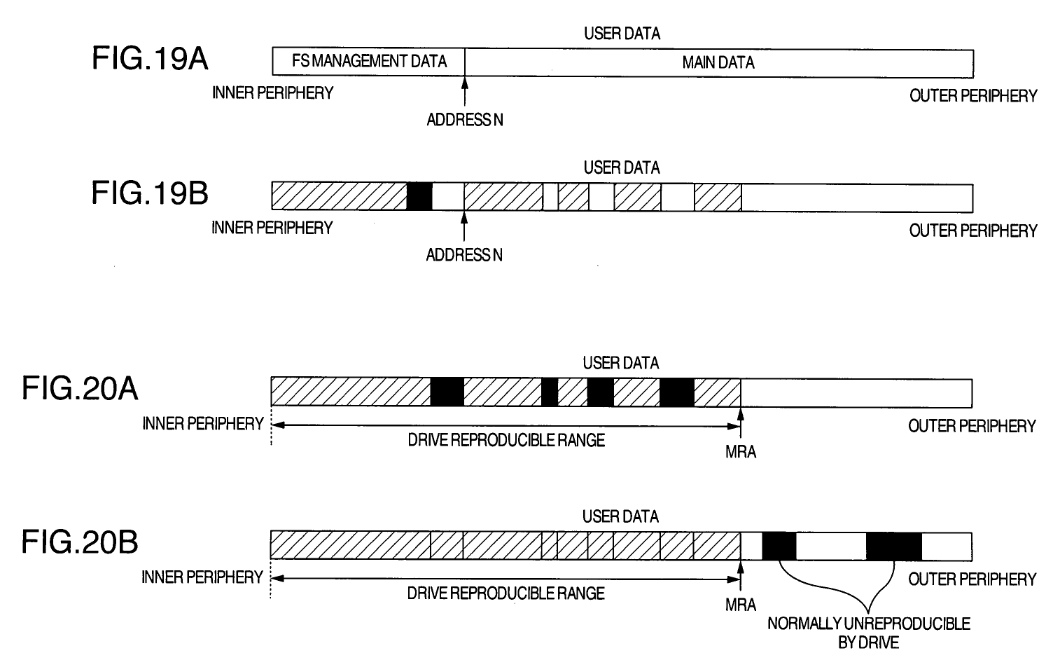

FIG. 19A shows an exemplary usage of the user data area from the inner periphery to the outer periphery, which is divided into two sub-areas at an address N (not recognized by the drive) for use by the host as an FS management data area for recording data related to file system management information and a main data area for recording data (file) transferred from the host. The file system management information recorded in the FS management data area includes such information as the name and recorded location of a file recorded in the main data area, a directory structure, and the like. FIG. 19B shows a method of recording the disc which is used with the user data area divided as shown in FIG. 19A. The FS management data area is used in such a manner that data is sequentially written from the inner periphery toward the outer periphery, while data is recorded at a plurality of arbitrary locations in the main data area.

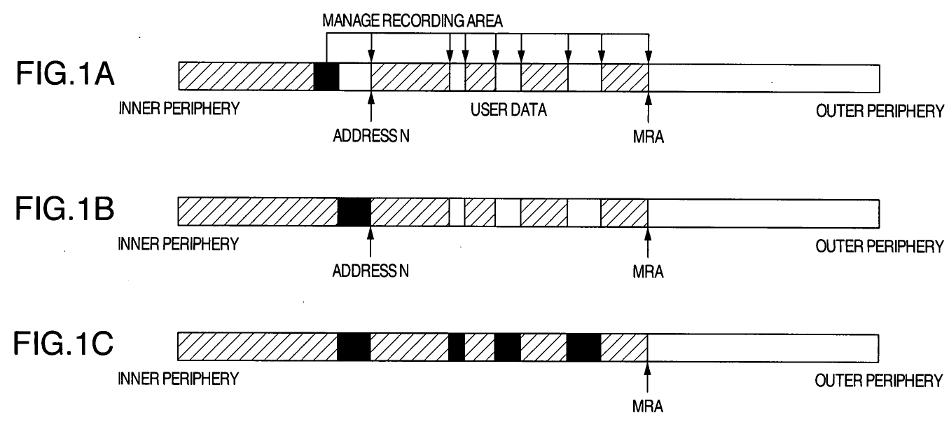

FIG. 1 is a diagram for explaining a method of finalizing the disc which has the FS management data area on the inner peripheral side and the main data area outside of the FS management data area, as shown in FIGS. 19A, 19B. FIG. 1A shows that the latest file system management information recorded in the FS management data area manages all recorded ranges on the disc, or areas in which necessary files have been recorded. For prohibiting an additional write into this disc, an unrecorded range within the FS management data area up to the address N, as shown in FIG. 19B, is forced to be a recorded unused area.

For implementing the prohibition of additional write, an additional write prohibition recording instruction is provided between the drive and host, and the drive receives from the host the additional write prohibition recording instruction, a recording start address, and the number of recording blocks, or the last recorded address N, and records additional write prohibition data (interpreted as an unused area by the drive during reproduction) generated within the drive. FIG. 25 is a flow chart illustrating the foregoing operation. When the unrecorded range is used up in the FS management data area, the file system management information is not updated even though a new file is recorded in the user data area, and hence main data cannot be updated, with the result that the additional write can be prohibited.

FIG. 1C is a diagram for explaining a method of prohibiting an additional write by the drive which automatically detects recorded and unrecorded ranges and changes an unrecorded range up to the MRA to a recorded unused area.

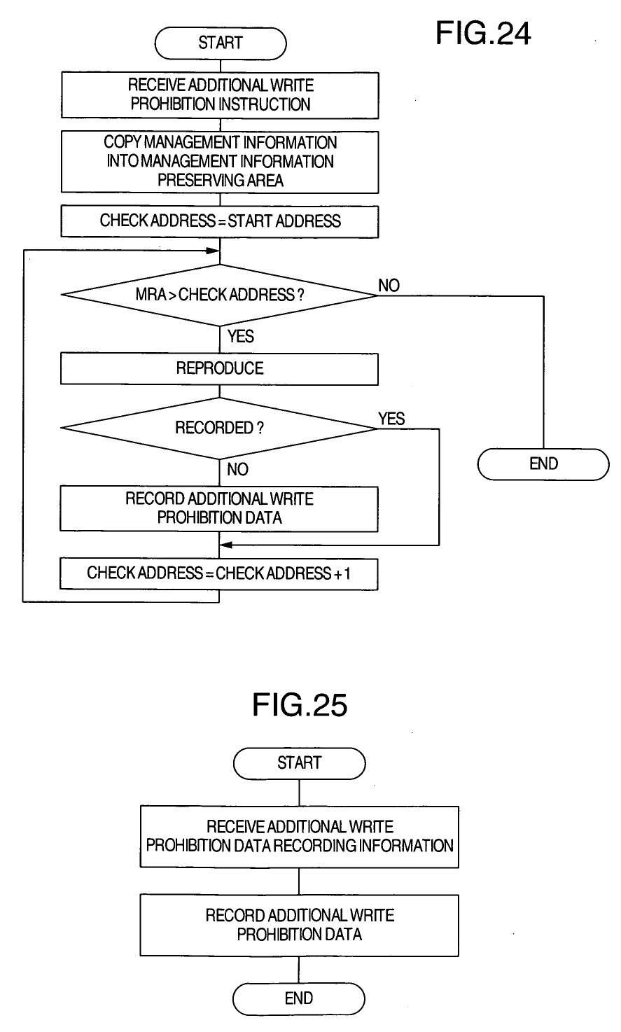

For accomplishing the prohibition of additional write, an additional write prohibition instruction is provided between the drive and host. Upon receipt of this instruction from the host, the drive copies the latest management information within the temporary management information preserving area into the management information preserving area, sets an address at which a check operation is performed (check address) at the start address of the user data area, as shown in the flow chart of FIG. 24, and determines whether the location indicated by the check address is recorded or unrecorded. When unrecorded, the drive records the additional write prohibition data at the location indicated by the check address. After this operation, the check address is incremented by one, and the processing for reproduction and recording, as required, is repeated while the check address is smaller than the MRA.

As a result, after the end of the processing, the resulting disc has the user area which includes a recorded range sequentially from the innermost location to the address pointed by the MRA, as shown in FIG. 1C.

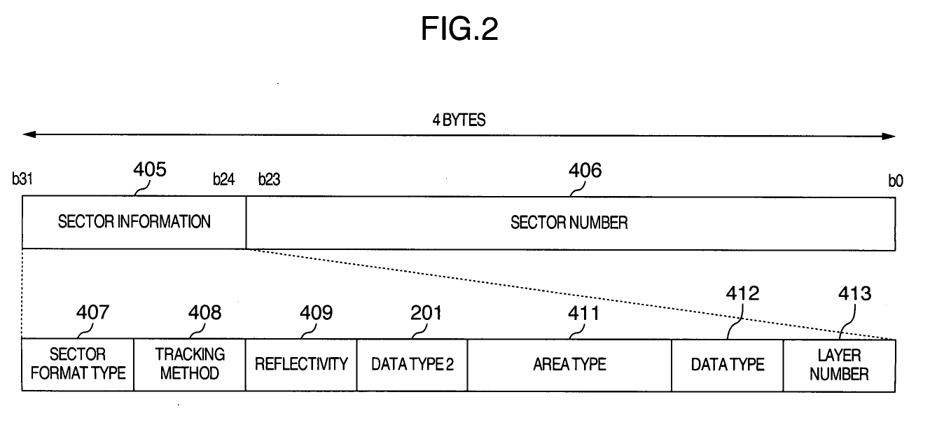

FIG. 2 shows a data format for the additional write prohibition data for use in creating the recorded unused area used in the description in connection with FIGS. 1A, 1B, 1C.

A data type 2 is newly added to a spare area for sector information of 6-byte ID data in the DVD data format described in FIG. 5. For indicating the additional write prohibition data, a flag is set for this data to distinguish the additional write prohibition data from the conventional recording data. Alternatively, a reserve area (RSV) 403 in FIG. 4 may be used to provide a flag, or a spacial pattern may be used for the main data 305, in order to define the additional write prohibition data.

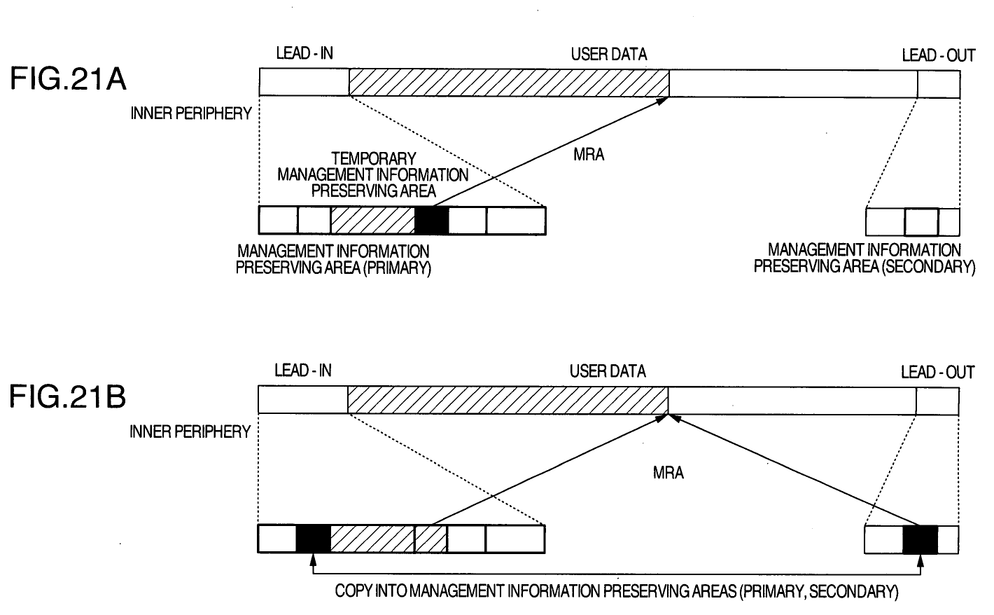

FIGS. 21A, 21B are diagrams showing the operation of copying the latest management information recorded in the temporary management information preserving area into the primary and secondary management information preserving areas. This operation is included in the flow chart of FIG. 24. Upon receipt of the additional write prohibition instruction from the host, the drive copies the latest management information within the temporary management information preserving area, which correctly indicates the MRA, into the management information preserving area. Thus, the drive determines whether or not a disc is prohibited from an additional write depending on whether or not data has been recorded in the management information preserving area.

Also, the MRA included in the management information recorded in the management information preserving area in this event points to the boundary between a recorded range and an unrecorded range within the data area.

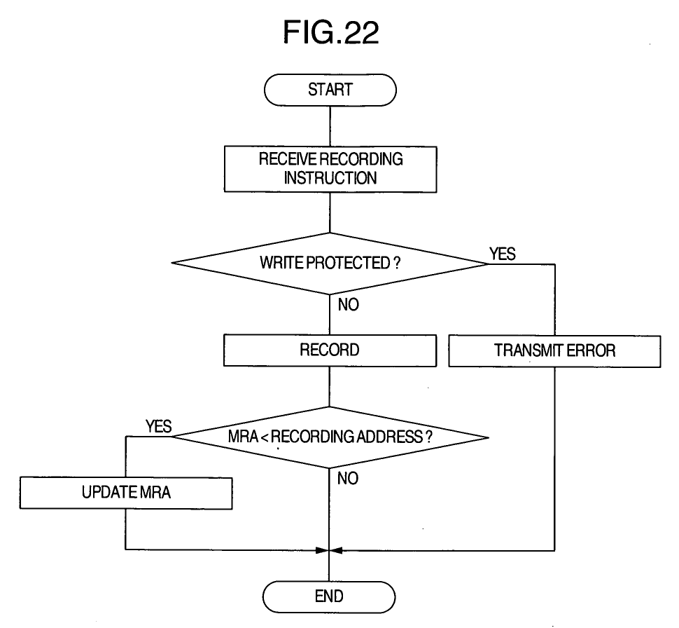

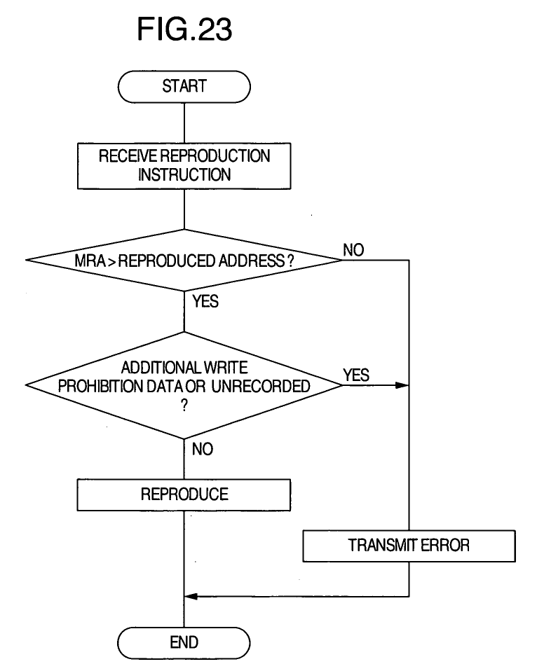

FIGS. 22 and 23 illustrate recording/reproducing processes of the drive in flow chart form.

FIG. 22 illustrates the recording process. Upon receipt of a recording instruction from the host, the drive confirms whether or not the management information has been recorded in the management information preserving area of a disc, and returns an error to the host for indicating that the disc cannot be recorded if the management information has been recorded in the management information preserving area. If the management information preserving area has not been recorded, the drive records data at an address specified by the host, and compares the recording address with the MRA of the disc. Then, the drive terminates the recording process if the recording address is smaller than the MRA, and updates the MRA of the disc before the recording process is terminated if the recording address is larger than the MRA.

FIG. 23 illustrates the reproducing process. Upon receipt of a reproduction instruction from the host, the drive confirms that a reproducing address received from the host is smaller than the MRA recorded on a disc, and reproduces data for transmission to the host if an unused area flag is not added to data. However, if the specified address is larger than the MRA, or if the unused flag is added to data, the drive returns an error to the host for indicating that the disc cannot be reproduced.

Finally, referring to FIGS. 20A, 20B, description will be made on how irregularly recorded data cannot be reproduced in the drive.

FIG. 20A illustrates a recording situation of a disc when the drive specifies an unrecorded range as a recorded unused range using the additional write prohibition data after receipt of an additional write prohibition instruction. FIG. 20B illustrates the disc which is subsequently recorded in an irregular manner. When such a disc is loaded into the drive, the drive reads the MRA recorded in the management information preserving area upon loading of the disc, and cannot reproduce data recorded on the disc outside of the MRA because the drive is permitted to reproduce only data at addresses smaller than the MRA.

Thus, an additional write prohibition function is implemented by the drive using the MRA for all recording modes, as shown above.

This system can be implemented by the optical disc recording/reproducing apparatus illustrated in FIG. 13.

The device techniques according to the present invention mainly relate to the microcomputer 1316 in the optical disc recording/reproducing apparatus, wherein the microcomputer 1316 has an internal or an external program ROM which stores a program, and executes operations in accordance with the program. All instructions issued from the host to the drive are interpreted by the microcomputer 1316 for controlling another device which make up the drive.

Therefore, the present invention can be readily practiced by adding the additional write prohibition function to the program stored in the ROM associated with the microcomputer.

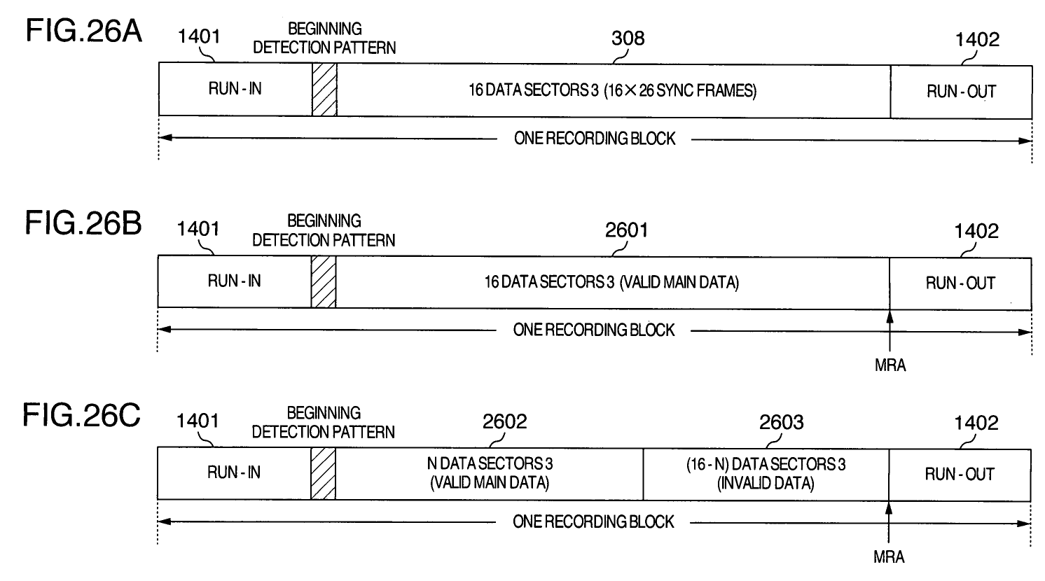

FIG. 26A and FIGS. 14A, 14B show a recording block which is composed of a data sequence comprised of 16 sets of 16 data sectors 3 described in connection with FIGS. 14A, 14B or 26 SYNC frames shown in FIG. 11, a run-in comprised of a fixed pattern and a beginning detection pattern indicative of the beginning of the 16 data sectors 3 added to the head of the data sequence, and a run-out added to the tail of the data sequence.

FIGS. 26B, 26C are diagrams each showing the relationship between a position pointed by an address pointer which indicates a recording area on a disc, such as the MRA, and substantial main data.

It is important that the address for use in managing a recording area on a disc actually indicates a recording area on the disc. Generally, however, personal computers and the like handle data in 2 kbyes, i.e., in data sectors during recording and reproduction. This often causes additionally written data to be less than one ECC unit of 32 kbytes, and the additionally written data to be divided by 2×N kbytes.

FIG. 26B shows a disc in which all 32 kbytes are filled with valid user data 2601, and FIG. 26C shows a disc in which only 2×N kbytes of the foregoing 32 kbytes are filled with valid user data 2602, and the remaining data is invalid data 2603 which was arbitrarily generated by the drive.

The operation of the drive associated with the discs illustrated in FIGS. 26B, 26C will be described with reference to the optical disc recording/reproducing apparatus illustrated in FIG. 13.

Main data sent from the host together with a recording instruction through the interface 1315 is once stored in the RAM 1309 connected to the encoder 1311 until 32 kbytes of data are collected. Since recording instructions from the host are generated in succession, the main data stored in the RAM 1309 is recorded on the disc 1301 in units of 32 kbytes through the subsequent scrambling, error-correction coding, and modulation.

However, when the host wishes to record, for example, only 8 kbytes of user data on the disc 1301, a forced recording instruction is sent to the drive for forcedly recording data stored in the RAM 1309. In this event, the drive automatically generates arbitrary additional data for the remaining 24 kbytes of data to forcedly generate 32 kbytes of main data which undergoes the remaining scrambling, error correction coding, and modulation before it is recorded on the disc 1301, in a manner similar to the process associated with normal recording.

Thus, the technique described in connection with FIG. 2 is utilized, and the algorithm illustrated in FIG. 23 is applied as well in such a situation.

Specifically, in data sectors composed as shown in FIG. 26C, a flag for identifying valid user data from invalid data arbitrarily generated by the drive is added to each of data sectors 3 in one recording block, such that this identification flag is detected during reproduction to handle the invalid data in a similar manner to additional write prohibited data.

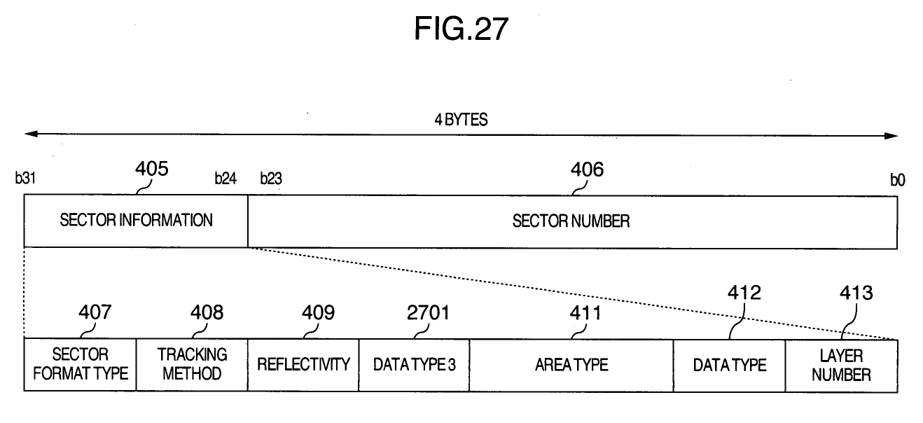

FIG. 27 is a diagram showing a data format for the ID which includes a data type 32701 for identifying valid user data from invalid data, used in the description on FIGS. 26A, 26B, 26C.

The data type 32701 is newly added to a spare area for the sector information of the 6-byte ID data in the DVD data format described in connection with FIG. 5. When the data type 32701 indicates invalid data arbitrarily generated by the drive, a flag is set to this data type 32701 to enable the distinction of the invalid data from conventional main data. Alternatively, invalid data can be defined by using the reserve area 403 in FIG. 4, or using part of the SYN code 701 to set a flag thereto. Also, when there is a management data area which is set in units of recording block units, flags related to all data sectors in one recording block may be managed in a collective manner, or all data sector information recorded in one recording block can be recorded as well in the management data area in units of sectors.

While the ID 401 is used herein, it is possible to exercise the address management in units of recording blocks and the address management in units of fractional recording blocks by providing flags in units smaller than the recording block in a data area indicative of sector information.

Other than the advantage of the ability to readily prevent tampering by forcing unrecorded ranges inside of the outermost recording address to be recorded ranges during the finalization as described above, the address detection using the address 401 generally included in data can be made faster than the address detection using physical addresses as described with reference to FIGS. 15A, 15B, thus resulting in such advantages as a faster access to target data, a stable servo control conducted with a consistent amount of light reflected from the disc at all times, and the like.

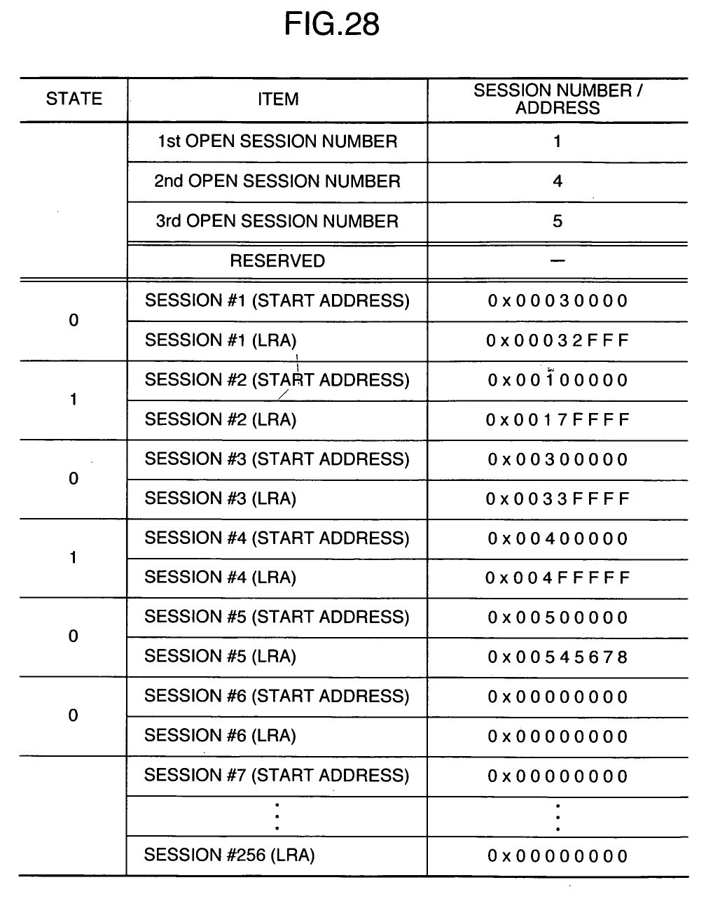

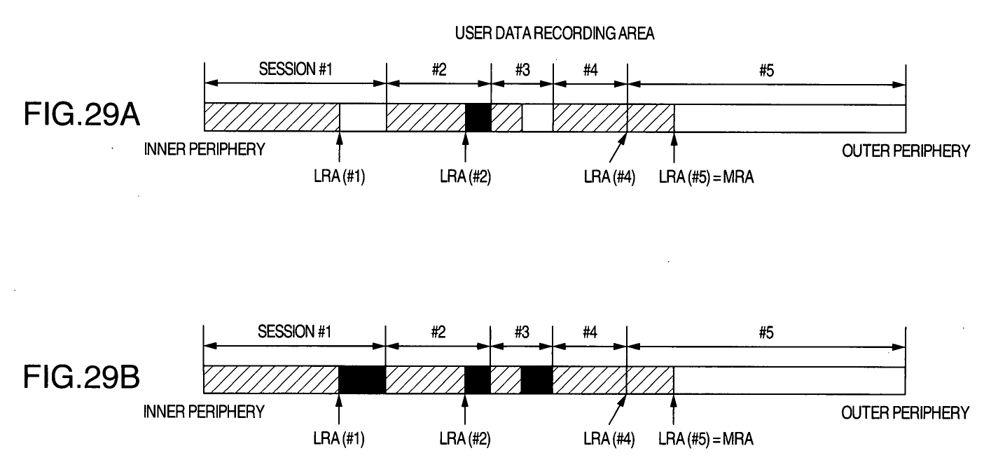

Referring next to FIGS. 28, 29A, 29B, description will be made on the applicability of the present invention, even including the concept of the session and track, as can be seen in the conventional DVD-R and the like.

For managing ranges recorded by the drive, a write-once DVD includes management information such as an open session number for an open session to which an additional write is permitted, and the start address and last recorded address (LRA) of each session (or also called the “R-zone”). Also, since the LRA of each session is utilized by a file system or the like, the LRA is required to continuously indicate a correct address, to which user data has been recorded, even in a closed session to which an additional write is not permitted.

In an example shown in FIG. 28, a 1-bit flag is further added to the information for indicating the state of each session. Specifically, in a situation in which 256 sessions are permitted at maximum, five sessions exist, and a maximum of three open sessions are permitted, the first, fourth, and fifth sessions are shown to be open, i.e., an additional write is permitted to these sessions. In addition, a rule is establish to prevent a once closed file from being opened again.

This flag indicative of the state of each session not only indicates the open and closed states but also indicates whether or not the associated session includes a range into which data can be physically recorded, where “0” indicates that “the session includes an area into which additional data can be physically written,” and “1” indicates that “additional data cannot physically be written into the session.” FIG. 28 shows that session #1 and session #4 have no range into which additional data can be physically written. FIG. 29A shows a recording area of a disc indicated by the management information shown in FIG. 28. In FIG. 29A, sections filled with slant lines drawn from upper right to lower left indicate ranges in which valid user data have been recorded; solid black areas indicate ranges in which invalid data have been recorded, for example, arbitrary data recorded by the drive for filling up an unrecorded range of a session upon closing the session or after the session has been closed.

It can be seen from FIG. 29A that the MRA used in FIGS. 1A, 1B, 1C matches the LRA in the last session. Also, in FIG. 29A, the LRA in session #4 is smaller by one than the session start address of session #5, indicating that no more additional write is possible into session #4. From the fact that session #2 has been fully recorded up to the start address of the next session using invalid data, it can be determined that no additional write is physically possible into session #4.

Using the flag indicative of session information included in FIG. 28, unrecorded ranges are filled up in all sessions except for the last session. Specifically, leaving those sessions with the flag set at “1” unchanged, the drive records invalid data in unrecorded ranges included in those sessions with the flag set at “0” upon receipt of a finalize command, as shown in FIG. 29B. Subsequently, the drive copies the recording area management information including the MRA (=LRA of the final session) recorded in the temporary management information preserving area into the management information preserving area, as shown in FIGS. 21A, 21B. In this event, while the advantage of tampering prevention has already been included in the session information itself, further advantages can be provided, including faster accesses, stable servo characteristics, and the like.

Also, in this system, since a closed session is never opened again, it is possible to reduce a time required for finalization by forcing the drive to record invalid data in unrecorded ranges of closed sessions during an idling state. A recording/reproducing apparatus adapted to perform such an operation can be implemented only by modifying the processing program executed by the microcomputer 1316, shown in FIG. 13.

It should be further understood by those skilled in the art that although the foregoing description has been made on embodiments of the invention, the invention is not limited thereto and various changes and modifications may be made without departing from the spirit of the invention and the scope of the appended claims.

1. A data recording method for sequentially recording data on a recording medium having a plurality of recording areas in response to a recording request from a host, said method comprising the step of:
recording information indicative of whether or not an unrecorded portion is included in said plurality of recording areas on said recording medium.

2. A data recording method for sequentially recording data on a recording medium having a plurality of recording areas in response to a recording request from a host, said method comprising the steps of:
recording user data and first identification data on said recording medium in response to a recording request from said host;
recording information indicative of whether or not an unrecorded portion is included in said plurality of recording areas on said recording medium; and
sensing an unrecorded portion on said recording medium from said information in response to an additional write prohibition request from said host to record additional write prohibition data and second identification data in said unrecorded portion.

3. A data recording method according to claim 2, further comprising the step of:
recording an outermost recorded addresses used to record the user data on said recording medium, after recording the user data and the first identification data on said recording medium in response to a recording request from said host.

4. A data recording method according to claim 3, wherein said outermost recorded address of said recording medium is stored at a predetermined location of said recording medium in response to an additional write prohibition request from said host.

5. A data recording method according to claim 1, wherein each of said first identification data and said second identification data has a flag added thereto.

6. A data recording method according to claim 4, further comprising the step of preventing said recording medium from being recorded upon request for recording on said recording medium from said host when said outermost recorded address has been stored at the predetermined location on said recording medium in response to the additional write prohibition request from said host.

7. A data recording apparatus for sequentially recording data on a recording medium having a plurality of recording areas in response to a recording request from a host, said apparatus comprising:
an encoder for generating first identification data in response to a data recording request from said host, and generating second identification data in response to an additional write prohibition request from said host; and
an optical pickup for recording user data and the first identification data on said recording medium in response to a user data recording request from said host, recording information indicative of whether or not an unrecorded portion is included in said plurality of recording areas on said recording medium, sensing an unrecorded portion on said recording medium from said information in response to an additional write prohibition request from said host, and recording the additional write prohibition data and second identification data in said unrecorded portion.

8. A data recording apparatus according to claim 7, wherein said optical pickup records an outermost recorded address used to record the user data on said recording medium after recording the user data and the first identification data on said recording medium in response to a recording request from said host.

9. A data recording apparatus according to claim 8, wherein said outermost recorded address of said recording medium is stored at a predetermined location of said recording medium in response to an additional write prohibition request from said host.

10. A data recording apparatus according to claim 7, wherein each of said first identification data and said second identification data has a flag added thereto.

11. A data recording apparatus according to claim 9, wherein said optical pickup prevents said recording medium from being recorded upon request for recording on said recording medium from said host when said outermost address value has been stored at the predetermined location on said recording medium in response to the additional write prohibition request from said host.
